(19) United States
(12) Patent Application Publication
(10) Pub. No.: US 2025/0054296 A1
(43) Pub. Date: Feb. 13, 2025

(54) DETECTION METHOD AND SYSTEM FOR DETECTING A BUILDING PART ON A CONSTRUCTION SITE

(71) Applicant: Umdasch Group Ventures GmbH, Amstetten (AT)

(72) Inventors: Florian DOBER, Neufurth (AT); Martin Brandl, Maria Taferl (AT)

(21) Appl. No.: 18/848,056

(22) PCT Filed: Apr. 28, 2023
(86) PCT No.: PCT/EP2023/061223

§ 371 Date: Sep. 17, 2024

(30) Foreign Application Priority Data
Apr. 29, 2022 (EP) 22170876.1

(51) Int. Cl. G06V 20/10; G06V 10/764

(52) U.S. Cl. CPC G06V 20/176; G06V 10/764

(57) ABSTRACT

System and detection method for detecting a building part on a construction site, comprising the following steps: i) acquiring at least one camera image of the construction site at an acquisition position; ii) generating data points in a three-dimensional coordinate system; iii) recognizing data points belonging to a formwork element iv) determining, in a stored building model, the visible area of a building part to be erected that is visible from the acquisition position according to a current construction progress; v) assigning the data points belonging to the formwork element to the visible area of the building part to be erected when the formwork element is arranged in the forming position for erecting the building part; and vi) detecting the building part when a specified number of data points belonging to the formwork element are assigned to the visible area of the building part to be erected.

The invention relates to a method and system for detecting a building part on a construction site, in particular in the shell construction erection phase. Furthermore, the invention relates to a method for monitoring a construction progress of a building, in particular during the shell construction erection phase.

By means of the technical monitoring of a building, during the construction phase it can already be determined whether a predetermined construction schedule is adhered to or whether there are construction errors. The real building can be captured by means of cameras or other sensors and compared with a plan or a model of the building. On the basis of this comparison, the construction progress can be derived and possible construction errors can be recognised.

Compliance with the construction schedule and the detection and prevention of construction errors is essential for the successful construction of buildings. Construction errors lead to an increase in costs due to their necessary correction and can in turn cause a time delay, which can again have a negative effect on costs due to the delayed acceptance and commissioning of the building. So far, construction errors and the progress of construction have usually been determined as part of an inspection and documentation by specialists, which is time consuming and labour intensive. It is therefore a need of many companies to be able to detect construction errors and construction progress automatically and without human intervention.

One possible way of obtaining information about a building during construction is to use wireless sensor units, which are attached directly to the work equipment on the construction site. Such sensor units are known, for example, from WO 2020/038949 A1. Depending on the design, the sensor units can transmit, for example, the spatial position of the work equipment or measured values such as temperature, humidity and pressure via a radio system. Disadvantageously, the sensor units are directly exposed to the harsh environmental conditions on the construction site, which can lead to failure of the sensor units and to false measurement data. Furthermore, in addition to a stable radio connection, a reliable power supply to the sensor units must also be ensured. Another disadvantage of wireless sensor units is the effort required in attaching, disassembling, and maintaining the sensor units. In addition, theft is a problem on construction sites. It is also disadvantageous that systems with wireless sensor units have mostly been developed and optimised for special applications. Adjusting of the sensor units for other applications usually involves with great effort.

With regard to recording the construction progress of a building, camera-based systems are much more flexible and easier to handle. Although these systems are not able to provide immediate measurement data such as temperature, humidity or pressure on building parts, these systems allow a comprehensive overview of a building during the erection phase, in particular during the shell construction erection phase. By means of image processing software, the captured building can be analysed and compared with a model, whereby the construction progress can be determined. By means of training data, the systems can be flexibly adapted to new conditions and buildings.

A method for monitoring construction sites is known from WO 2019/137814 A1 or DE 10 2018 200 221 A1 in which a building object is captured visually by means of imaging sensors and a feature of a constructive part of the building object is recognised from the captured image data. The feature can be, for example, an electrical installation box of a precast reinforced concrete wall. The imaging sensors may be arranged on a construction machine or on a crane.

Further methods for monitoring construction sites are known from JP 2021026281 A and JP 2020181241 A.

In YANG JUN ET AL: “Image-Based 3D Semantic Modeling of Building Facade”, Sep. 15, 2014 (2014-09-15), SAT 2015 18TH INTERNATIONAL CONFERENCE, AUSTIN, TX, USA, Sep. 24-27, 2015; [LECTURE NOTES IN COMPUTER SCIENCE; LECT.NOTES COMPUTER], SPRINGER, BERLIN, HEIDELBERG, PAGE(S) 661-671, a modelling method based on a 3D model is described using the example of a building facade. Thereby a point cloud is obtained from stereo images.

A typical problem that arises when monitoring buildings by means of imaging sensors is that building parts are possibly covered by other building parts. For example, if a wall is erected behind another wall or column, it may only be partially visible to the camera and thus cannot be reliably recognised. Another problem is that concrete walls, in particular are difficult to distinguish from other concrete walls or ceilings because of the similar colours and structures. If the transitions between the individual walls and floors are not correctly recognised, construction errors cannot be detected and the construction progress cannot be determined correctly.

In the light of these explanations, the object of the present invention is to alleviate or even completely eliminate the drawbacks of the prior art. It is preferably the object of the present invention to provide a method and a system with which building parts such as walls or floors can be reliably recognised. Furthermore, it is an object of the invention to provide a method with which the construction progress can be reliably monitored.

These objects are achieved by a detection method for detecting a building part according to claim 1, a method for monitoring a construction progress according to claim 12 and a system for detecting a building part according to claim 13. Preferred embodiments are given in the dependent claims.

According to the invention, the detection method according to claim 1 comprises the following steps:
i) acquiring one or more camera images of the construction site with at least one, preferably at least two digital camera/s spaced apart from each other at an acquisition position;
ii) generating data points in a three-dimensional coordinate system, preferably in the form of a point cloud, the data points representing the construction site;
iii) recognising data points in the three-dimensional coordinate system belonging to a formwork element on the construction site, which is arranged in a forming position;
iv) determining, in a stored building model, the visible area of a building part to be erected, for example a wall or ceiling element, which is visible from the acquisition position according to a current construction progress;
v) assigning the data points belonging to the formwork element to the visible area of the building part to be erected when the formwork element is arranged in the forming position for erecting the building part on the construction site; and
vi) detecting the building part on the construction site when a specified number of data points belonging to the formwork element is assigned to the visible area of the building part to be erected.

The invention is based on the finding that formwork elements on construction sites are more visible in many situations and can be captured more easily than concrete walls or concrete ceilings, which merge into one another in terms of colour and structure and in some cases can only be distinguished from one another with difficulty. Due to their size, colour, structure and shape, formwork elements, in particular frame formwork elements, stand out against the building and can therefore be more easily identified and distinguished from other objects by means of image processing software. In particular, frame formworks typically have easily identifiable structures such as cross struts on the back side and has a characteristic colour and frame contour on the front side, depending on the manufacturer. In the case of frame formworks for walls, characteristic holes are also provided for anchor rods. If a formwork element is now in a forming position on the construction site, it can be assumed that a building part to be erected with the formwork element is present, even if the cast-in concrete may not yet be fully cured. One advantage of the invention is that it is also possible to recognise building parts that are partially covered by other building parts, because only the regions of the building parts to be erected that are visible from the acquisition position are taken into account when assigning the data points that belong to the formwork element. To this end, a stored 3D model of the building is used. The model can be present as a BIM model (BIM=Building Information Modelling) or be derived from such a model. The model can be stored in a memory. In step i), one or more camera images of the construction site are captured. Thereby, the construction site comprises the structure to be erected, for example a building, a bridge, or a tunnel, and any construction site equipment, in particular the work equipment. The acquisition position at which the at least one digital camera is located is preferably a position at which the at least one digital camera can visually capture the entire building to be erected from a viewing angle. Obviously, it is also possible to provide a plurality of digital cameras, which each capture a part of the building, wherein their camera images can be merged in order to depict the entire building. It is preferred that the acquisition position is essentially static, i.e. invariable. However, it can also be provided that the acquisition position changes over time. In case of a change in the acquisition position, its position is determined (again). This can be done, for example, manually or by means of a GNSS unit (Global Navigation Satellite System). However, the acquisition position is preferably determined via control points on the construction site. The control points can be, for example, (reference) markers, which are arranged on the construction site and the position of which is known or has been measured. For example, white boards with a black symbol can be used as markers. The control points can also be distinctive points on the construction site, such as, for example, the constructed edge of an already existing building. The position of the distinctive points is also known, for example by measuring. An advantage of the control points is that movements of the crane due to wind or load uptake are compensated as well as a change of the camera position. If a plurality of digital cameras is provided, each digital camera is arranged at its own acquisition position. The at least one digital camera can be designed as a stereo camera. However, it can also be provided that two digital cameras spaced apart from each other are forming a stereo camera. In such a case, the two digital cameras can be arranged, for example, on a common support frame. In step ii), data points are generated that represent the construction site in a three-dimensional coordinate system. The data points are preferably in the form of a point cloud. The data points can be generated from the previously recorded, in particular two-dimensional, camera images. However, it is also possible that the data points can be generated by means of a distance measuring device, in particular a LIDAR system (Light Imaging, Detection and Ranging). Each data point may be assigned to a position in the three-dimensional space. The position is determined by coordinates. In step iii), those data points are recognised that belong to a formwork element on the construction site that is arranged in a forming position. The forming position of a formwork is that position in which concrete can be cast into the receiving space between formwork elements in order to produce the building part. For example, in the case of vertical walls to be erected, the forming position can be recognised by the fact that the formwork element is oriented vertically. Data points belonging to the formwork element can be recognised by classification and an associated segmentation. Algorithms for classification are known from the state of the art. Image analysis libraries and/or a classifier trained with training examples, for example a neural network, can be used to classify the single pixels. Algorithms for segmentation and classification of objects in images are known in the state of the art. Training data can be used for classification of formwork elements. The classification or segmentation can take place in the recorded camera images or in the generated data points in three-dimensional space. If segmentation and classification is carried out in the individual camera images, the data points in the three-dimensional coordinate system are linked to the pixels of the camera images to determine those data points that belong to the formwork element. If the data points are generated from the pixels of the camera images, this link is already given. It can also be provided that other formwork elements that are not in a forming position are also recognised in step iii). However, these formwork elements are then not taken into account in the detection of the building part. In step iv), that visible area of a building part to be erected is determined in a stored building model, which is visible from an acquisition position according to a current construction progress. The visible area of a building part can be understood to include those areas that, for example, are not obstructed by other building parts (to be erected) when viewed from the acquisition position. The current construction progress is taken into account. The construction progress indicates which building parts have already been erected and which not. The visible area can be determined by determining which areas of a building part are impinged by visual beams from the acquisition position at which a digital camera is located. The orientation, i.e. the alignment, and intrinsic camera parameters of the digital camera are also taken into account. The building part to be erected may be, for example, a wall, a floor or a ceiling. In step v), the data points belonging to the formwork element are assigned to the visible area of the building part to be erected if the formwork element is arranged in the forming position for erecting the building part on the construction site. The formwork element is arranged in particular for erecting the building part when it is in a forming position and is adjacent to the position of the building part to be erected and is preferably oriented parallel to its surface. Finally, in step vi), the building part is detected on the construction site when a specified number of data points belonging to the formwork element is assigned to the visible area of the building part to be erected. As long as the formwork element is present, the building part can be classified as “in progress”. It is advantageous that only the visible area of the building part to be erected is taken into account, whereby the error rate in the assignment can be reduced. In summary, the method according to the invention makes it possible to detect a building part, for example a wall, a ceiling or a floor, in a forming position by means of a formwork element if the formwork element can be assigned to a building part to be erected that is at least partially visible from an acquisition position depending on the construction progress. Steps i)-vi) can, but do not have to, be carried out in the order specified. For example, step iv) can also be carried out before step i). Single steps can be carried out at least partly also overlapping in time, if technically feasible.

According to a preferred embodiment, it is provided that the visible area of the building part to be erected is subdivided into virtual cells, and the data points belonging to the formwork element are assigned to the cells of the building part according to their position in the three-dimensional coordinate system, the building part being detected on the construction site when at least one data point is assigned, respectively, to a specified number of cells of the building part. The visible area can be determined by subdividing all building parts in the building model into cells and taking into account those cells that are impinged by a visual beam from the acquisition position of a digital camera. Preferably, a data point is assigned to a cell if a data point is within a cell. The cells may be, for example, spherical, cylindrical, cuboid- or cube-shaped. In one embodiment, the building to be erected is subdivided into cuboid-shaped cells, the edges of the cube being 5 cm to 20 cm, in particular substantially 10 cm, long. The cells can protrude beyond the boundaries of the building part to be erected. In this way, the data points of the formwork elements, which are arranged on a building part to be erected, can be within the cells. Additional cells can also be provided outside the building part 9 to be erected.

In step iii), recognising the data points in the three-dimensional coordinate system that belong to the formwork element can be carried out on the basis of a segmentation and classification of segmented components of the one camera image or the plurality of camera images. Segmentation and classification methods are known from the state of the art. For example, specially adapted image processing algorithms or trained networks can be used. In particular, image analysis libraries in a database and/or models trained with training examples, for example neural networks, can be used for segmentation. Formwork elements can be recognised by means of segmentation and classification in the camera images. By assigning data points in the three-dimensional space to pixels in the camera images, those data points that belong to a formwork element can be identified. The assignment of data points to pixels can be carried out in particular by generating the data points from the camera images.

In one embodiment, it may be provided that a distinction is made on the basis of an orientation and a formwork type of the formwork element as to whether the formwork element is arranged in a forming position or a storage position, and the formwork element is only taken into account in step iii) if it is arranged in the forming position. This means that the formwork element is no longer taken into account when it is in a storage position. Whether a formwork element is in a forming position or in a storage position depends on the formwork type and its orientation. If it is a formwork element for a vertical wall, it is in a forming position when the formwork element is vertically aligned adjacent to the wall. If formwork elements are arranged parallel and opposite one another, so that a receiving space is formed between them, it can also be assumed that they are in a forming position. If, on the other hand, the formwork element leans against an already erected wall, is arranged outside the building or lies on the ground, the formwork element is in a storage position. If it is a formwork element for a ceiling, it is in a forming position when the formwork element is aligned horizontally adjacent to a ceiling to be erected. If, on the other hand, the formwork element for a ceiling leans against a wall, it is in a storage position.

It is preferred if at least two digital cameras are provided at a respective acquisition position, wherein the at least two digital cameras form a stereo camera and the digital cameras each record camera images substantially simultaneously. The at least two digital cameras can be fastened to a support frame and be connected to one another via a connecting element, for example a rod. The support frame may include hinges to align the digital cameras in a vertical and/or horizontal direction. Furthermore, the support frame can include a fastening element, in particular a holding clamp, for fastening the support frame to an object, for example to a crane. With regard to the size of the buildings to be captured, it is advantageous if the at least two digital cameras have a distance of at least 50 cm, preferably of at least 80 cm or of at least 100 cm, from one another. Preferably, the two digital cameras have a distance of essentially 120 cm. The digital cameras each record only two-dimensional camera images.

Thus, in step ii), the data points in the three-dimensional coordinate system can be generated from two simultaneously captured camera images of the at least two digital cameras. The position of the data points in three-dimensional space can be derived from the geometric properties of the digital cameras and the distance between the digital cameras.

For visual acquisition of the construction site, it is advantageous if the acquisition position is arranged on a construction site equipment, in particular on a crane or a post, or on another building. If a plurality of digital cameras is provided, the acquisition positions of those digital cameras can also be arranged on the construction site equipment or on the other building. In an especially preferred embodiment, two digital cameras forming a stereo camera are provided and the acquisition positions of these digital cameras are arranged on the construction site equipment, in particular a crane, or on another building. Advantageously, the at least one digital camera is protected against damage and theft if it is arranged at an elevated location, such as on a crane or a post.

In order to be able to better compare the data points with the model of the building, it is advantageous if one or more control points, in particular one or more markers, are provided on the construction site, and the data points in step ii) are oriented and/or scaled in accordance with the one or more control points. The control points can be formed, in particular, by signs or posters. Alternatively, the control points can be formed by characteristic features on the construction site. The control points have a pattern that is easily identifiable. By means of the at least one control point, the orientation, i.e. the alignment, and the scaling of the data points in the three-dimensional coordinate system is simplified.

With regard to efficient data processing, it is advantageous if data points that do not belong to a formwork element are discarded. In other words, only data points belonging to a formwork element are used in step v).

For the purpose of data protection, it is advantageous if people are detected in the camera images and/or in the data points in the three-dimensional coordinate system and at least faces of the people are anonymised, for example by pixelation. Detecting people and faces can be carried out by segmenting the camera images and classifying segmented image components. Segmentation and classification methods are known from the state of the art. For example, specially adapted image processing algorithms or trained networks can be used. In particular, image analysis libraries in a database and/or models trained with training examples, for example neural networks, can be used for segmentation. A neural network is preferably used for segmentation. Anonymisation can also be achieved by placing an area over the recognised faces. It is only important that people are no longer clearly identifiable to human viewers.

It is advantageous if the formwork element is a frame formwork element or a ceiling formwork element. These types of formwork elements are particularly easy to recognise due to their shape, structure and colour. Frame formworks consist of a frame, in particular a steel frame, in which a formwork panel is inserted and fixed. Due to this characteristic, frame formworks are particularly easy to recognise. Ceiling formwork elements are supported by formwork supports and generally have front or edge formworks that prevent the concrete from leaking. Ceiling formwork elements are therefore also easy to recognise.

According to the invention, a method for monitoring a construction progress of a building, in particular in the shell construction erection phase, is also provided. The method comprises the following steps:
a) repeatedly executing a detection method for detecting a building part on a construction site of the type described above;
b) marking a building part as completed if the building part has been detected according to step vi) of the detection method and the data points belonging to the formwork element arranged on the construction site for erecting the building part are no longer assigned to the visible area of the building part when the detection method is carried out again in step v).

If a formwork element has been removed from the building part and therefore, in step v) of the detection method, the data points belonging to the formwork element are no longer assigned to the building part, it can be assumed that cast-in concrete is cured and therefore the building part has been completed. As long as data points of a formwork element are assigned to a building part, the building part can be marked as “in progress”. Thus, the construction progress can also be updated when a building part is completed.

The invention further relates to a system for detecting a building part on a construction site, in particular in the shell construction erection phase. The system thereby comprises:
at least one, preferably two, digital camera/s for acquiring camera images from the construction site, wherein the at least one digital camera can be arranged at an acquisition position; and
a processing unit configured to carry out the following steps:
i) controlling the at least one digital camera to capture one or more camera images from the construction site;
ii) generating data points in a three-dimensional coordinate system, preferably in the form of a point cloud, the data points representing the construction site;
iii) recognising data points in the three-dimensional coordinate system belonging to a formwork element on the construction site;
iv) determining said visible area of a building part to be erected, for example a wall or ceiling element, in a stored building model, which is visible from the acquisition position according to a current building progress, wherein the building model is stored in a memory;
v) assigning the data points belonging to the formwork element to the visible area of the building part to be erected when the formwork element is arranged in a forming position for erecting the building part on the construction site; and
vi) detecting the building part on the construction site when a specified number of data points belonging to the formwork element is assigned to the visible area of the building part to be erected.

The system is thus configured to carry out the method described above. All advantages, developments and features of the method can therefore be transferred to the system. The processing unit can, but does not have to, be formed by a single unit. The processing unit can also be provided as a distributed processing unit formed from a plurality of (sub) units or modules that are spatially separated from each other. Steps i)-vi) can, but do not have to, be carried out in the order specified. For example, step iv) can also be carried out before step i). The steps can also be carried out overlapping in time.

In a preferred embodiment, at least two digital cameras are provided, which are arranged on a support frame, the digital cameras being spaced apart from one another by at least 50 cm, preferably by at least 100 cm. The support frame may include a rod connecting the at least two digital cameras. The two digital cameras form a stereo camera for generating three-dimensional images.

In the following, the invention will be described in more detail with reference to figures, to which, however, it shall not be restricted, in which:

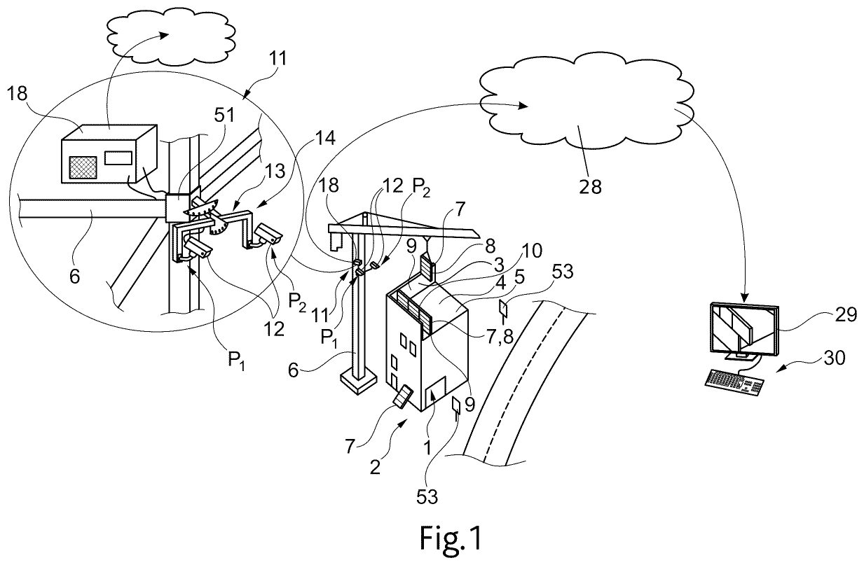

FIG. 1 shows a construction site where the system according to the invention is used for detecting a building part;

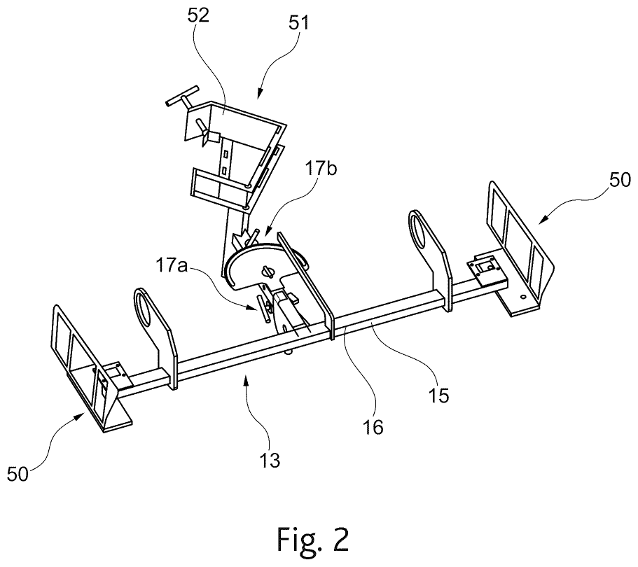

FIG. 2 shows in detail a support frame for digital cameras, which together form a stereo camera;

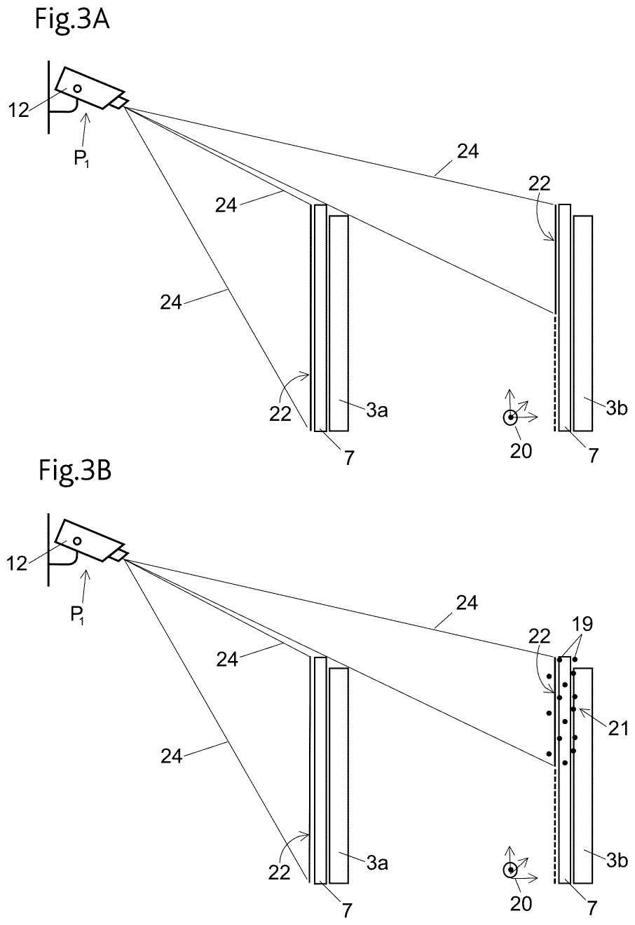

FIG. 3A and FIG. 3B schematically illustrate a visible area and data points of a building part;

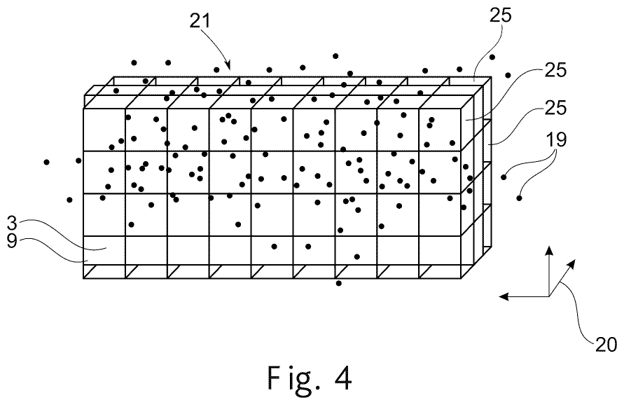

FIG. 4 schematically shows data points assigned to a building part; and

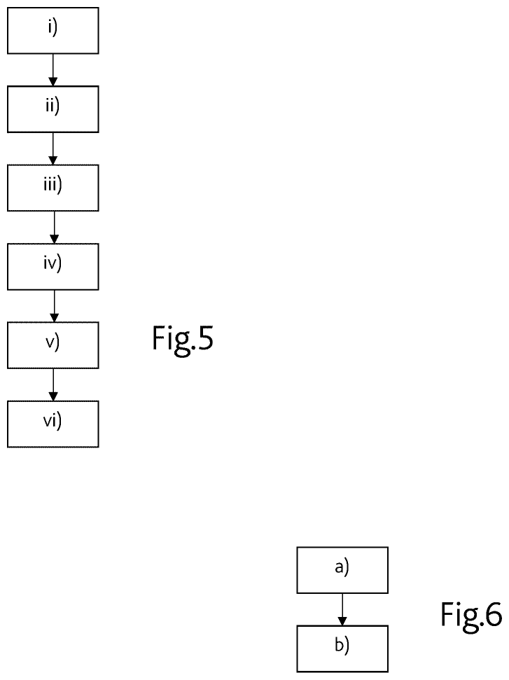

FIG. 5 schematically shows the sequence of a detection method according to the invention for detecting a building part on a construction site;

FIG. 6 schematically shows the sequence of a method according to the invention for monitoring a construction progress of a building; and

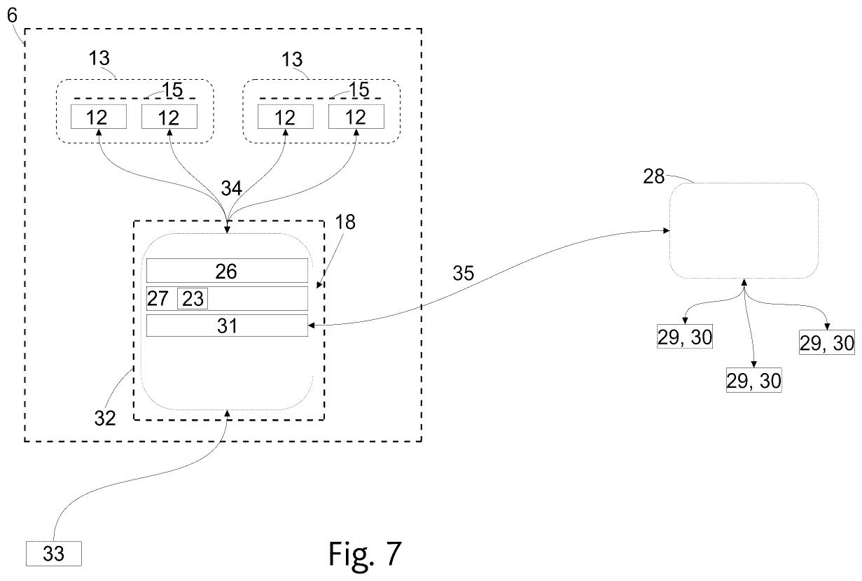

FIG. 7 schematically shows the exchange of data in a system for detecting a building part on a construction site.

FIG. 1 shows a building 1 that has not yet been completed in the shell construction erection phase on a construction site 2. Building 1 is a multi-storey building 1a in the form of a house. In the shell construction erection phase, the shell construction is not yet completed. This means that not all walls 3, floors 4 and ceilings 5 of the building 1 have yet been erected.

In the illustration shown, a crane 6 transports a formwork element 7, in particular a frame formwork element 8, to the top floor of the not yet completed building 1. The formwork element 7, like the other formwork elements 7 already located on the building 1, serves to produce a building part 9, in the present case a wall 3, that still is to be erected. For this purpose, a plurality of formwork elements 7 are arranged opposite one another and, if necessary, also next to one another, so as to form a receiving space 10 into which concrete (not shown) can be filled. This position of the formwork elements is referred to as the forming position. During the curing of the concrete, the building part 9 is a work in progress. After the concrete is cured, the formwork elements 7 are removed again and the building part 2 is completed. In FIG. 1, a formwork element 7 is not in the forming position and is leaning against a wall 3 of the lowest floor of building 1. This formwork element 7 is in a storage position.

For the successful erection of a building 1, it is essential to adhere to a predetermined construction schedule. For this purpose, construction errors should be recognised at an early stage and construction progress should be captured regularly. In order to determine construction faults and the progress of construction, individual building parts 9, i.e. walls 3, floors 4 and ceilings 5, must be detected during the construction phase.

According to the invention, a system 11 for detecting a building part 9 is provided for this purpose. In the embodiment shown, the system 11 includes two digital cameras 12, which are fastened to a support frame 13. The support frame 13 is in turn mounted on the crane 6, from where the digital cameras 12 can capture the building 1 in the construction phase. The two digital cameras 12 together form a stereo camera 14. The two digital cameras 12 are each arranged at a separate acquisition position P₁, P₂. The digital cameras 12 are each configured to record two-dimensional camera images.

The support frame 13 is shown on an enlarged scale in FIG. 2 and has a connecting element 15, preferably a rod 16 or a profile element, to which the digital cameras 12 can be fastened. The support frame 13 further includes at least two joints 17a, b, one of the joints 17a allowing the connecting element 15 to be pivoted in the vertical direction and one of the joints 17b allowing the connecting element 15 to be pivoted in the horizontal direction. The joints 17 can each be locked, for example by means of locking pins that engage in locking holes in order to block the pivoting of the connecting element 15. The mounting points 50 for mounting the digital cameras 12 are preferably arranged at the ends of the connecting element 15 and are in particular spaced apart from each other by at least 50 cm. With a fastening element 51, for example a holding clamp 52, the support frame 13 can be detachably fastened to an object, in particular the crane 6.

The system 11 further includes a processing unit 18 (see FIG. 7), which not necessarily is a single centralised unit. It may also be provided that the processing unit 15 is a distributed processing unit 18 that is divided into a plurality of distributed (sub) units or modules that are spatially separated from each other. Thus, the processing steps performed by the processing unit 15 can also be performed at different locations.

The system 11 is designed to carry out the method described below, wherein the specified steps do not necessarily have to be performed in the order described. Individual steps can also be carried out interchanged or at least partially or completely overlapping.

In a first step i), at least one two-dimensional camera image of the building 1 that has not yet been completed is recorded by means of the digital cameras 12. It is preferred that the camera images of the two digital cameras 12 are recorded substantially simultaneously.

In a second step ii), data points 19 are generated in a three-dimensional coordinate system 20 from at least two camera images, that were each recorded substantially simultaneously by the digital cameras 12, which data points 19 represent the construction site 2, i.e. the building 1 and any work equipment, for example formwork elements 7 (see FIGS. 3A, B and FIG. 4). Each data point 19 is assigned to a unique position in the form of coordinates in the three-dimensional coordinate system 20. The amount of data points 19 can also be referred to as the point cloud 21. Each data point 19 belongs to an object or a person on the construction site 2. To align and scale the point cloud 21, control points 53 can be placed on the construction site. The control points 53 facilitate the determination of distances and orientations.

In a third step iii), data points 19 in the three-dimensional coordinate system 20 that belong to a formwork element 7 in a forming position on the construction site 2 are recognised. In particular, the invention is based on the finding that formwork elements 7 can be recognised more easily because they stand out more easily from other objects on the construction site 2 due to their shape, colour, and structure. Recognising formwork elements 7 can be done, in particular, on the basis of segmentation and subsequent classification of the segmented image components. Those data points 19 that, in step ii), emerged from pixels belonging to formwork elements 7 can be declared as data points 19 belonging to a formwork element 7. The forming position of a formwork for a wall is, for example, that position in which concrete can be cast into the receiving space 10 in order to produce the building part 9. For example, in the case of walls 3 to be erected, the formwork position can be recognised by the fact that the formwork element 7 is oriented vertically.

In a fourth step iv), that visible area 22 of a building part 9 to be erected is determined in a stored building model 23, in particular a digital BIM model (see FIG. 7), which is visible from the acquisition positions P₁, P₂ according to a current construction progress. The visible area depends on the acquisition position P₁, P₂ and the orientation of the digital camera 12. In this step, the building part 9 is not yet classified as completed. The aim is to detect the building part 9 on the construction site 2. This should be done by means of the existing formwork elements 7.

The determination of a visible area 22 from an acquisition position P₁, P₂ is shown in FIG. 3A. FIG. 3A schematically shows two walls 3a, b arranged one behind the other and a digital camera 12 located at an acquisition position P₁. From the point of view of the digital camera 12, the back wall 3b is at least partially covered by the front wall 3a, i.e. some visual beams 24 impinge the front wall 3a, but not the back wall 3b or the formwork element 7, which is also shown. The visual beams 24 are schematically depicted in FIG. 3A. That region on which visual beams 24 impinge from the acquisition position P₁ of the digital camera 12 represents the visible area 22 of a building part 9. Based on the knowledge of the acquisition position P₁ and the orientation of the digital camera 12, as well as intrinsic parameters, it is possible to determine, in a building model 23, that visible area 22, which is visible from the acquisition position P₁. The visible area 22 can be determined depending on the progress of the construction, since at a later date, the visible area 22 can be restricted due to additional building parts 9.

In a fifth step v), those data points 19 that belong to the formwork element 7 in the forming position are assigned to the visible area 22 of the building part 9 to be erected when the formwork element 7 is arranged in a forming position for erecting the building part 9 on the construction site 2. The formwork element 7 is arranged in particular for erecting the building part 9 when it is in a forming position and is adjacent to the position of the building part 9 to be erected and is preferably oriented parallel to the surface thereof.

In FIG. 3B, data points 19 are indicated that belong to a formwork element 7, which is arranged in a forming position for erecting the wall 3b. The data points 19 can therefore be assigned to the wall 3b.

The assignment of the data points 19 is shown schematically in FIG. 4 and can be carried out by dividing the visible area 22 of a building part 9 to be erected into cells 25 and assigning those data points 19 that are within the cells 25 to the corresponding cells 25. The cells 25 can project beyond the boundaries of the building part 9 to be erected, so that the data points 19 of the formwork element 7 are in the cells 25. In the illustration shown, the cells are cube-shaped. The edge lengths can be, for example, 10 cm.

In step vi) the building part is detected when a specified number of data points 19 belonging to the formwork element 7 is assigned to the visible area 22 of the building part 9 to be erected. This can be done, in particular, by having a certain number of cells 25 filled with data points 19. Thus, if a certain number of filled cells 25 is present, the building part 9 to be erected can be declared as present.

FIG. 5 schematically shows the sequence of the detection method described so far.

FIG. 6 shows the sequence of a method for monitoring a construction progress of a building 1. In this case, the above-described method for detecting a building part 9 is carried out several times (step a). When a building part 9 is detected, it is classified as “in progress” as long as the data points 19 of the formwork element 7, which was arranged for erecting the building part 9, are assigned to the visible area 22 of the building part 9. Once the data points 19 of the formwork element 7, which was arranged for erecting of the building part 9, are no longer assigned to the visible area 22 of the building part 9, i.e. the formwork element 7 is no longer required for the building part 9, the building part 9 is classified as “completed” (step b).

FIG. 7 schematically shows the structure of the system 11 for detecting a building part 9. As already mentioned above, the processing unit 18 does not have to be present as a single unit, but can also consist of a plurality of decentralised (sub) units that are spatially separated from each other. In the present case, the processing unit 18 includes a central processing unit 26, which carries out or initiates steps i)-vi) of the method. The building model 23, which is used in step iv), is stored in a memory 27, which in the exemplary embodiment shown forms a component of the processing unit 18 or can alternatively be arranged in a server 28. Further data, such as training data for segmentation and classification of formwork elements 7, can also be stored in the memory 27. Detected building parts 9 and the detected construction progress can be displayed on a screen 29 of a computer 30 (see also FIG. 1). Detected people, preferably anonymised, as well as detected construction equipment, such as concrete buckets or trucks, can also be displayed on the screen 29. The processing unit 18 includes a data transmission unit 31 for connection to the server 28. The processing unit 18 may be fastened to the crane 6 by means of a mounting bracket 32. The processing unit 18 is supplied with electrical energy 33 via a line. The energy can come from a supply network or an energy storage. The digital cameras 12 are connected to the processing unit 18 via data and power connections 34. In the illustration shown, the processing unit 18 is connected to the server 28 by means of the data connection 35. The computer 30 can also be connected to the server 28 and thus control the processing unit 18 and the digital cameras 12 or retrieve data from them.

1. A detection method for detecting a building part on a construction site comprising the following steps:
i) acquiring one or more camera images of the construction site with at least one digital camera at an acquisition position;
ii) generating data points in a three-dimensional coordinate system the data points representing the construction site;
iii) recognising data points in the three-dimensional coordinate system belonging to a formwork element on the construction site which is arranged in a forming position;
iv) determining that visible area of a building part to be erected in a stored building model, which is visible from the acquisition position according to a current construction progress;
v) assigning the data points belonging to the formwork element to the visible area of the building part to be erected when the formwork element is arranged in the forming position for erecting the building part on the construction site; and
vi) detecting the building part on the construction site when a specified number of data points belonging to the formwork element is assigned to the visible area of the building part to be erected.

2. The detection method according to claim 1 wherein the visible area of the building part to be erected is subdivided into virtual cells, and the data points belonging to the formwork element are assigned to the cells of the building part according to their position in the three-dimensional coordinate system, the building part being detected on the construction site when at least one data point is assigned, respectively, to a specified number of cells of the building part.

3. The detection method according to claim 1 wherein in step iii) recognising of data points in the three-dimensional coordinate system that belong to the formwork element can be carried out on the basis of a segmentation and classification of segmented components of the one camera image or the plurality of camera images.

4. The detection method according to claim 1 wherein a distinction is made on the basis of an orientation and a formwork type of the formwork element as to whether the formwork element is arranged in a forming position or a storage position, and the formwork element is only taken into account in step iii) if it is arranged in the forming position.

5. The detection method according to claim 1, wherein at least two digital cameras are provided at a respective acquisition position, wherein the at least two digital cameras form a stereo camera and the digital cameras each simultaneously record camera images.

6. The detection method according to claim 5 wherein in step ii) the data points in the three-dimensional coordinate system are generated from two simultaneously captured camera images of the at least two digital cameras.

7. The detection method according to claim 1 wherein the acquisition position is arranged on a construction site equipment or on another building.

8. The detection method according to claim 1 wherein one or more control points are provided on the construction site, and the data points in step ii) are oriented and/or scaled according to the one or more control points.

9. The detection method according to claim 1 wherein data points that do not belong to any formwork element are discarded.

10. The detection method according to claim 3 wherein people are detected in the camera image or the plurality of camera images and/or in the data points in the three-dimensional coordinate system, and at least faces of the people are anonymised.

11. The detection method according to claim 1 wherein the formwork element is a frame formwork element or a ceiling formwork element.

12. A method for monitoring a construction progress of a building, comprising the following steps:
a) repeatedly executing a detection method for detecting a building part on a construction site according to claim 1;
b) marking a building part as completed if the building part has been detected according to step vi) of the detection method and the data points belonging to the formwork element arranged for erecting the building part on the construction site are no longer assigned to the visible area of the building part when the detection method is carried out again in step v).

13. A system for detecting a building part on a construction site comprising:
at least one digital camera for acquiring camera images from the construction site, wherein the at least one digital camera can be arranged at an acquisition position; and
a processing unit configured to carry out the following steps:
i) controlling the at least one digital camera to capture one or more camera images from the construction site;
ii) generating data points in a three-dimensional coordinate system, the data points representing the construction site;
iii) recognising data points in the three-dimensional coordinate system belonging to a formwork element on the construction site which is arranged in a forming position;
iv) determining that visible area of a building part to be erected in a stored building model, which is visible from the acquisition position according to a current building progress, wherein the building model is stored in a memory;
v) assigning the data points belonging to the formwork element to the visible area of the building part to be erected when the formwork element is arranged in the forming position for erecting the building part on the construction site; and
vi) detecting the building part on the construction site when a specified number of data points belonging to the formwork element is assigned to the visible area of the building part to be erected.

14. The system according to claim 13 wherein at least two digital cameras are provided, which are arranged on a support frame, the digital cameras being spaced apart from each other by at least 50 cm.

15. The detection method according to claim 1, wherein the building part on the construction site is in a shell construction erection phase.

16. The detection method according to claim 1, wherein there are at least two digital cameras spaced apart at the acquisition position acquiring the one or more camera images of the construction site.

17. The detection method according to claim 1, wherein the data points are generated in the form of a point cloud.

18. The detection method according to claim 7, wherein the acquisition position is arranged on a crane or a post.

19. The detection method according to claim 8, wherein the one or more control points are one or more markers.

20. The detection method according to claim 10, wherein at least faces of the people are anonymized by pixelation.
